(19) United States
(12) Patent Application Publication
(10) Pub. No.: US 2010/0141620 A1
(43) Pub. Date: Jun. 10, 2010

(54) FLAT LIGHT SOURCE WITH ELECTRODES FACING EACH OTHER AND METHOD FOR MANUFACTURING THE SAME

(75) Inventors: Jung Hyun Oh, Gyeonggi-do (KR); Suk Youn Suh, Gyeonggi-do (KR); Byung Soo Kim, Gyeonggi-do (KR); Jin Ho Lee, Gyeonggi-do (KR); Byeong Soo Lee, Gyeonggi-do (KR); Yong Ki Lee, Gyeonggi-do (KR); In Yong Choi, Gyeonggi-do (KR)

Correspondence Address: HUSCH BLACKWELL SANDERS LLP, 190 Carondelet Plaza, Suite 600, ST. LOUIS, MO, 63105, US

(73) Assignee: SSCP CO., LTD., Gyeonggi-do (KR)

(21) Appl. No.: 12/598,455

(22) PCT Filed: Apr. 30, 2008
(86) PCT No.: PCT/KR08/02475

§ 371 Date: Nov. 2, 2009

(30) Foreign Application Priority Data
May 2, 2007 (KR) 10-2007-0042666

(51) Int. Cl. H01J 61/30; G06F 3/038; H01J 9/24

(52) U.S. Cl. 345/206; 445/24; 29/592.1

(57) ABSTRACT

A flat panel display device including electrodes facing each other is disclosed. The flat panel display device, including at least one unit discharge cell, includes: a upper and a lower substrates; one or more first partition members for supporting and keeping apart the upper and the lower substrates; and a pair of electrodes, formed on the first partition members, for generating the electric field in discharge space of the unit discharge cell, wherein the pair of electrodes are formed on one or more leteral faces which are in contact with the discharge space among all the lateral faces of the first partition members, the pair of electrodes facing each other at a right angle, and wherein intenal space is formed inside of the first partition members.

### TECHNICAL FIELD

The present invention relates to a flat panel display device using the discharge phenomenon of plasma and a method for manufacturing the same; and more particularly, to the flat panel display device with a structure to discharge gas filled in discharge space by locating electrodes on partition members which are inserted between a upper substrate and a lower substrate and the method for manufacturing the flat panel display device.

### BACKGROUND ART

A flat panel display (FPD) device means a display device with a flat panel with a thickness equivalent to or less than one fourth of diagonal length of the display device, e.g., a thickness of from a few millimeters to a few centimeters. As a relatively lighter and thinner device with lower power consumption, the FPD device has gradually replaced a cathode ray tube (CRT) which was the longest serving technology in the history of display devices.

Such a flat panel display device is classified into an emissive type which makes the device self-emissive and a non-emissive type which requires a separate light source. The former includes PDP (plasma display panel), OLED (organic light emitting display), FED (field emission display), and the latter includes LCD (liquid crystal display) and the like. As the LCD is impossible to display any image without an external light source, a back light unit (BLU), i.e., a separate light source, is necessarily required. The BLU is widely used in a form of CCFL which can produce visible light by colliding the infrared light emitted from mercury gas excited by electron discharged by the high voltage electric field with the fluorescent substance; LED (light emitting device) which is operated by the electroluminescence phenomenon which is generated when the voltage is provided to a semiconductor; or FFL (flat fluorescent lamp) which diffuses light by exciting fluorescent substance by the infrared light generated from the discharged gas.

Since FFL uses a flat light source with only one lamp unlike CCFL which uses a line light source, it has advantages: sharply reduced number of components, automation in the manufacturing processes of BLUs and LCD panels, and easy adoption for large LCDs, which bring the public attention.

FIGS. 1 through 4 indicate an example of a flat panel display device 100 according to the conventional technology.

First of all, FIG. 1 presents the whole configuration of the flat panel display device 100, and FIG. 2 refers to the cross section viewed from A-A′ of FIG. 1. By reference of FIGS. 1 and 2, the flat panel display device 100 includes a upper substrate 101, a lower substrate 102, a partition member 103 for establishing space for a plurality of unit discharge cells while supporting the upper and the lower substrates, sealant 104 for sealing the upper and the lower substrates, discharge electrodes 105 for generating the electric field required for discharging gas in the discharge cell, fluorescent substance 106 for emitting visible light by the gas discharge and a gas inlet 107 through which gas is inputtable to the discharge cells.

The basic luminescent principle of the flat panel display device 100, i.e., the FFL, is similar to that of general fluorescent lamps. The electrons accelerated by the electric field generated by the discharge electrodes 105 flow and collide with the discharge gas in the discharge space. Herein, UV with a wavelength of, e.g., 253.7 nm is emitted and then the fluorescent substance 106 is excited by the discharged UV, thereby emiting the visible ray.

As shown in FIG. 2, the characteristic of the discharge electrodes 105 of the conventional flat panel display device 100 is that the discharge electrodes 105 are located on the lower substrate 102. In other words, as shown in FIG. 2, the structure in which four discharge electrodes 105 are installed in two discharge cells is illustrated as an exemple (Herein, FIG. 2 shows only two discharge cells because FIG. 2 is a drawing viewed from a cross section including the two discharge cells, although six discharge cells are included in the flat panel display device 100 by referring to FIG. 1.). It is found that the discharge electrodes 105 are located on first regions of the lower substrate 102 which are adjacent to both sides of the partition member 103 and second regions of the lower substrate 102 which are adjacent to the sealant 104.

The types of the discharge gas injected through the gas inlet 107 are largely classified into mercury-free and mercury-contained discharge gas. In case of using the mercury-free discharge gas, Xenon (Xe) which emits vacuum ultraviolet may be used, and if necessary, mixed gas including inert gas such as Xenon (Xe), Helium (He), Argon (Ar) and Krypton (Kr) may be used. In case of using the mercury-contained discharge gas, mixed gas with more inert gas including Neon (Ne), Argon (Ar) etc. is used.

FIG. 3 presents the structure of the partition member 103 of FIG. 1 in detail. A left drawing of FIG. 3 illustrates the shape of a longitudinal (Y direction) partition member 103 viewed from the X direction, and a right drawing of FIG. 3 illustrates the shape of the longitudinal partition member 103 viewed from the Y direction. It is inevitable to install a plurality of partition members, because the flat panel display device 100 must maintain the discharge space while controlling the difference between the pressure of the inside and the outside of the device. In short, the partition member 103 in the flat panel display device 100 may play a role in keeping the discharge space while at the same time supporting the upper and the lower substrates 101, 102. As illustrated, the partition member 103 may be rectangular-shaped and mainly made of glass.

FIG. 4 shows the structure of the discharge electrode 105 of FIG. 2 in detail.

By reference of FIG. 4, the discharge electrode 105 may be comprised of a metal layer 105A as an actual electrode, a dielectric layer 105B such as Al₂O₃, TiO₂ and a protective layer 105C such as MgO. Herein, the dielectric layer 105B is used for protecting the metal layer 105A and the protective layer 105C is for protecting the decay of the dielectric layer 105B.

FIGS. 5 through 9 indicate a manufacturing process of the flat panel display device 100 (mainly describe the manufacturing process of the lower substrate 102).

The step shown in FIG. 5 is a process to form the metal layers 105A which play a role as electrodes among the three layer structure of the discharge electrodes 105 which will be formed on the lower substrate 102 by the processes of FIGS. 5 through FIG. 9. FIG. 5 shows a process to build a structure of two discharge cells (toally six discharge cells) by forming four metal layers 105A on the lower substrate 102.

The step in FIG. 6 is a process to form the dielectric layers 105B on the metal layers 105A; the step in FIG. 7 is a process to form the protective layers 105C on the dielectric layers 105B; and the step in FIG. 8 shows a process to form the fluorescent substance 106 on the lower substrate 102 between a pair of the discharge electrodes 105.

Meanwhile, the upper substrate 101 may be prepared on which only the fluorescent substance 106 is established (unillustrated).

The step in FIG. 9 is a process for sealing the upper and the lower substrates 101, 102 by using the sealant 104.

The partition member 103 is installed between the upper and the lower substrates 101, 102. Herein, the partition member 103 is prepared through a separate process (unillustrated). After the sealing process, if the discharge gas is injected through the gas inlet 107 and the gas inlet 107 is tipped off, the process for manufacturing the flat panel display device 100 is completed. Since the process of the formation of the discharge electrodes and the fluorescent substances, the process of the sealing, and the process of the gas injection are well known to those who skilled in the art, the explanation thereabout will be omitted in the specification.

### DISCLOSURE

### [Technical Problem]

However, the conventional device had the following problems:

Firstly, since the metal layer 105A, the dielectric layer 105B, the protective layer 105C and the fluorescent substance 106 are all formed on the lower substrate 102, the lower substrate 102 may be thermally shocked during the heat treatment process repeated during the formation of the above-mentioned three-layer structure. With the thermal shock, a crack etc. occurs in the glass-made lower substrate 102 so that the lifespan of the flat panel display device 100 may be shortened.

Secondly, to create one group of discharge cells (for example, six discharge cells), the process for manufacturing the discharge electrodes 105, composed of three sub-steps, i.e., the calcination of the metal layers 105A, the calcination of the dielectric layers 105B and the deposition of the protective layers 105C, for one lower substrate may be required. Thus, in order to produce massive groups of such discharge cells, it is necessary to repeatedly perform the above-mentioned three sub-steps for each of the lower substrates. Therefore, the number of sub-steps included in the process may be increased, resulting in the reduction of the productivity and the increase in the cost of the device.

### [Technical Solution]

It is, therefore, one object of the present invention to provide a flat panel display device having a pair of discharge electrodes facing each other in a unit discharge cell by installing the discharge electrodes on partition members which are separately and massively produced and provided.

It is another object of the present invention to provide a method for manufacturing the flat panel display device without having to require the process for forming the metal layers, the dielectric layers, and the protective layers directly on the lower substrate, to thereby reduce the influence of thermal shock on the lower substrate and increase the lifespan and the performance of the device.

It is yet another object of the present invention to provide a method for massively manufacturing the flat panel display device capable of achieving the improvement of productivity thanks to the reduction the number of steps of the process and the automation of the process through the application of the robot assembling process by massively and separately producing many partition members containing the electrodes.

However, the objects of the present invention are not limited to the foregoing.

### ADVANTAGEOUS EFFECT

In accordance with the present invention, the flat panel display device has the following effects: (i) it is possible to improve productivity thanks to the reduced number of manufacturing steps included in the whole process and achieve the automation process such as a robot assembling; and (ii) it is possible to reduce the cost of the flat panel display device and reduce the influence of the thermal shock on the lower substrates (for example, soda lime glass which is inexpensive can be used for the substrates), because the upper and the lower substrates do not need to go through the necessarily accompanying calcination processes which are required to manufacture the electrodes at high temperature.

### DESCRIPTION OF DRAWINGS

The above objects and features of the present invention will become more apparent from the following description of the preferred embodiments given in conjunction with the accompanying drawings, in which:

FIG. 1 shows the whole configuration of the flat panel display device according to the conventional technology.

FIG. 2 refers to the cross sectoni viewed from A-A′ of FIG. 1.

FIG. 3 presents the partition member of FIG. 1.

FIG. 4 indicates the discharge electrodes of FIG. 2.

FIGS. 5 through 9 present manufacturing processes of the conventional flat panel display device.

FIG. 10 is a plane figure showing the whole configuration of the flat panel display device in accordance with the first embodiment of the present invention.

FIG. 11 is the cross section viewed from A-A′ of FIG. 10.

FIG. 12 presents the partition member of FIG. 10.

FIG. 13 illustrates the discharge electrode of FIG. 11.

FIG. 14 refers to other shapes of the partition member.

FIG. 15 shows the whole configuration of the flat panel display device in accordance with the second embodiment of the present invention.

FIG. 16 presents the partition member of FIG. 15.

FIGS. 17 through 20 illustrate the process of manufacturing the partition member in accordance with the present invention.

FIG. 21 presents the whole configuration of the flat panel display device in accordance with the third embodiment of the present invention.

FIG. 22 refers to the cross section viewed from A-A′ of FIG. 21.

FIG. 23 shows the partition member of FIG. 21.

FIG. 24 presents the electrodes of FIG. 22.

FIG. 25 shows still other shapes of the partition member in accordance with the present invention.

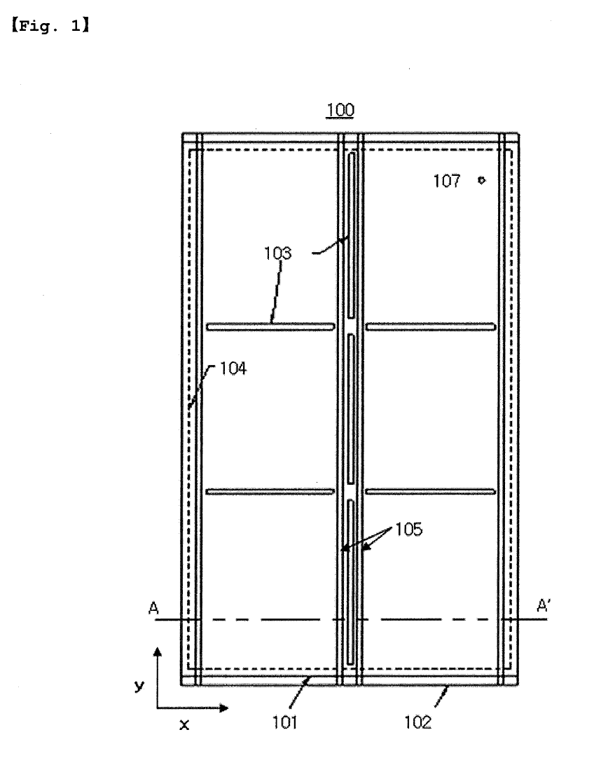

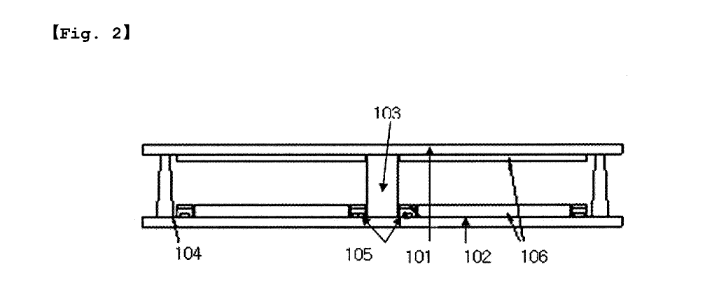

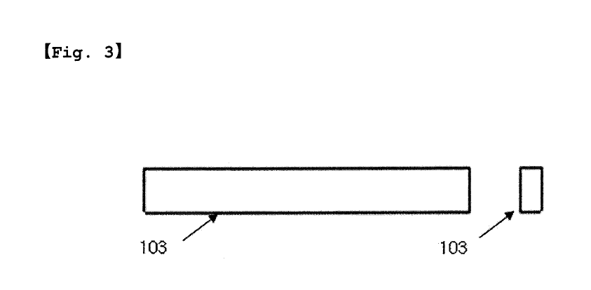

### BEST MODE

The configurations of the present invention for accomplishing the above objects of the present invention are as follows.

In one aspect of the present invention, there is provided a flat panel display device, including at least one unit discharge cell, including: a upper and a lower substrates; one or more first partition members for supporting and keeping apart the upper and the lower substrates; and a pair of electrodes, formed on the first partition members, for generating the electric field in discharge space of the unit discharge cell, wherein the pair of electrodes are formed on one or more leteral faces which are in contact with the discharge space among all the lateral faces of the first partition members, the pair of electrodes facing each other, and wherein intenal space is formed inside of the first partition members.

In another aspect of the present invention, there is provided a flat panel display device, including at least one unit discharge cell, including: a upper and a lower substrates; one or more first partition members for supporting and keeping apart the upper and the lower substrates; and a pair of electrodes, formed on the first partition members, for generating the electric field in discharge space of the unit discharge cell, wherein the pair of electrodes are formed on one or more leteral faces which are in contact with the discharge space among all the lateral faces of the first partition members, the pair of electrodes facing each other, and wherein one or more grooves are formed on the first partition members.

In yet another aspect of the present invention, there is provided a flat panel display device, including at least one unit discharge cell, including: a upper and a lower substrates; one or more first partition members for supporting and keeping apart the upper and the lower substrates; and electrodes, located inside the first partition members, for generating electric field in discharge space of the unit discharge cell(s), wherein a specific electrode located inside a specific first partition member of which both sides are in contact with neighboring unit discharge cells is common to the neighboring unit discharge cells.

In yet still another aspect of the present invention, there is provided a flat panel display device, including at least one unit discharge cell, including: a upper and a lower substrates for maintaining discharge space for the unit discharge cells; and first partition members for generating electric field in the discharge space while supporting and keeping apart the upper and the lower substrates, wherein the first partition members have groove(s) formed thereon to supply discharge gas into the discharge space.

In yet still another aspect of the present invention, there is provided a method for manufacturing a flat panel display device, including at least one unit discharge cell, discharge space for the unit discharge cells being located between a upper and a lower substrates, including the steps of: (a) forming multiple electrodes on a reference substrate; (b) cutting the reference substrate so as to include each of the electrodes; and (c) inserting the cut electrodes between the upper and the lower substrates.

### MODE FOR INVENTION

In the following detailed description, reference is made to the accompanying drawings that show, by way of illustration, specific embodiments in which the present invention may be practiced. These embodiments are described in sufficient detail to enable those skilled in the art to practice the present invention. It is to be understood that the various embodiments of the present invention, although different from one another, are not necessarily mutually exclusive. For example, a particular feature, structure, or characteristic described herein in connection with one embodiment may be implemented within other embodiments without departing from the spirit and scope of the present invention. In addition, it is to be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The embodiments of the present invention will be described, in detail, with reference to the accompanying drawings.

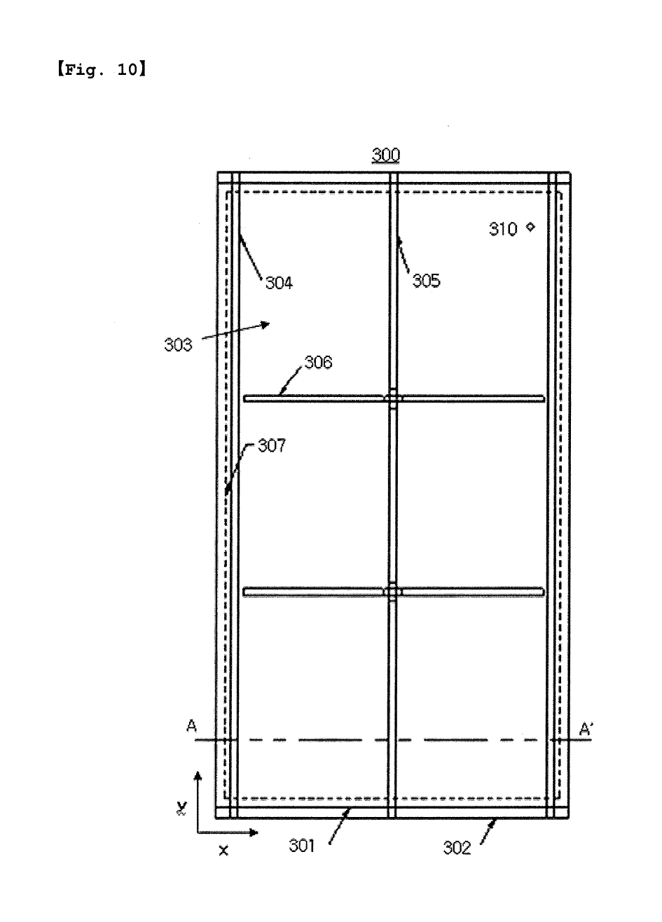

FIGS. 10 through 14 present a flat panel display device 300 in accordance with the first embodiment of the present invention.

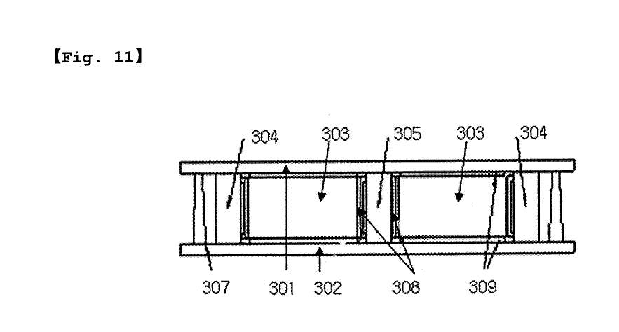

First of all, FIG. 10 refers to the whole configuration of the flat panel display device 300; and FIG. 11 indicates the cross section viewed from A-A′ of FIG. 10. By referring to FIGS. 10 and 11, the flat panel display device 300 may include a upper substrate 301, a lower substrate 302, partition members 304, 305, 306, sealant 307, discharge electrodes 308, fluorescent substance 309, a gas inlet 310 etc. The flat panel display device 300 may be comprised of multiple unit discharge cells 303. However, the flat panel display device 300 will be explained by referring to only one unit discharge cell for convenience' sake.

Moreover, the flat panel display device 300 of the present invention is considered to have six unit discharge cells in this specification, but the number of unit discharge cells included in the flat panel display device 300 may be varied.

In accordance with the first embodiment of the present invention, the flat panel display device 300 has a pair of the discharge electrodes 308 for generating the electric field in discharge space, wherein the discharge electrodes 308 are formed on the lateral faces of the partition members 304, 305 standing in rows in a Y direction with functions of separating and supporting the upper and the lower substrates 301, 302. Thus, the pair of discharge electrodes 308 in a unit discharge cell 303 may face each other.

On the other hand, as shown in FIG. 11, the fluorescent substance 309 may be located on the upper substrate 301 and the lower substrate 302 but it is not limited thereto. For example, it may be located either on the upper substrate 301 or on the lower substrate 302. In other case, it may be located on the partition members 304, 305, 306. Herein, it should be noted that the above-mentioned various examples may be applied to other embodiments of the present invention even without any special comments.

A procedure for operating the flat panel display device 300 with the structure of the electrodes facing each other is as follows: (a) when a voltage is applied to the discharge electrodes 308 on the partition members 304, 305, the discharge phenomenon starts partially; (b) when the voltage is applied for enough time, initial discharge passages with a shape of narrow band are created between the pair of discharge electrodes 308 facing each other; (c) when the applied voltage is increased after the initial discharge passages are created, the initial discharge passages are expanded in the vertical direction in the space between the electrodes; and (d) each expanded discharge passage is combined with adjacent discharge passages and thus the uniform and full discharge is provided.

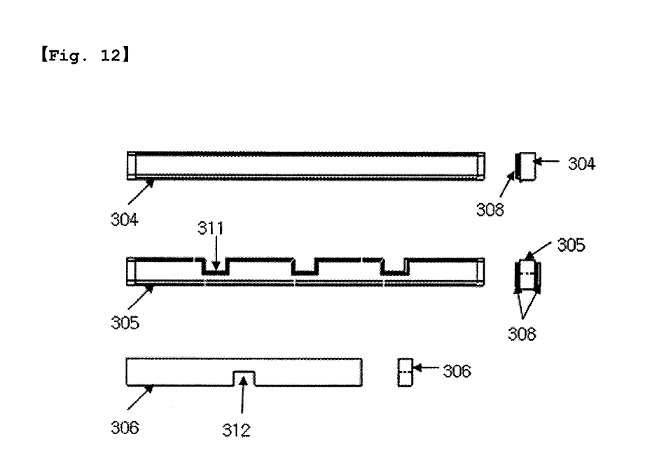

FIG. 12 refers to the configuration of the partition members of FIG. 10 more specifically. In FIG. 12, a top drawing shows the partition member 304; a middle drawing presents the partition member 305; and a bottom drawing refers to the partition member 306. Each of the partition members 304, 305, 306 is classified into a left and a right drawings. The left drawing refers to the partition members 304, 305 viewed from the X direction and the partition member 306 viewed from the Y direction; and the right drawing refers to the partition members 304, 305 viewed from the Y direction and the partition member 306 viewed from the X direction.

For convenience, the partition members will be explained in this specification by considering the partition members 304, 305 to be arranged in the Y direction and the member parallel 306 to be arranged in the X direction. The partition members 304, 305 along the Y direction and the partition member 306 along the X direction substantially cross at right angles. One unit discharge cell basically occupies the discharge space formed by the pair of partition members 304, 305 along the Y direction and the pair of partition members 306 along the X direction. Herein, if a unit discharge cell corresponds with the outermost one, the outermost partition member 306 may be omitted.

The structure of the partition members 304, 305 along the Y direction is classified by whether discharge cells are in contact with both sides of the partition member or one side of the partition member. In detail, the partition member 304 along the Y direction adjoins the discharge cells on one side thereof and the partition member 305 along the Y direction adjoins the discharge cells on both sides thereof.

Meanwhile, the partition member 306 along the X direction may have no discharge electrode formed thereon, however, it is not limited thereto. For example, the discharge electrode, functioning as a sumpplementary electrode, can be installed on the partition member 306. Further, it should be noted that the supplementary electrode may be applied as mentioned above in other example embodiments of the present invention even without any special comments.

The partition members may be shaped in a form of a continuous rod with the cross section of a square, a circle or a ring or a spot such as a sphere or a polyhedral. Further, the partition members may be made of glass, ceramic and the like. Furthermore, the cross section of the partition member may have shapes of a part of a circle, an ellipse or a polyhedron. It should be noted that a variety of examples of the partition member may be applied to other example embodiments of the present invention even without any special comments.

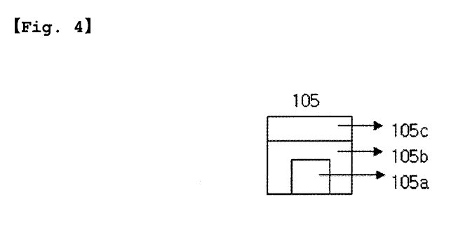

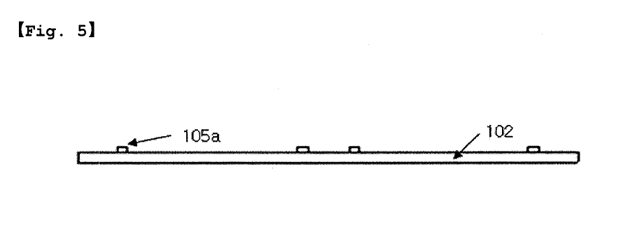

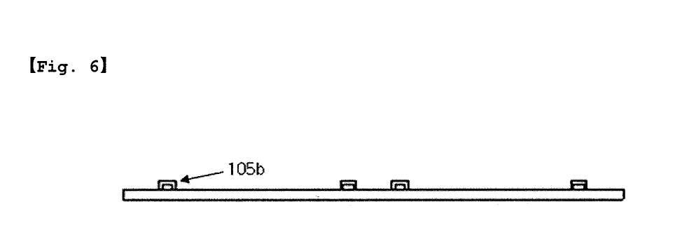

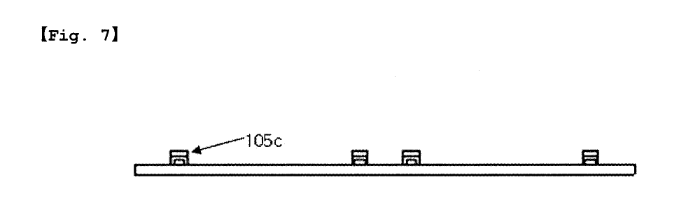

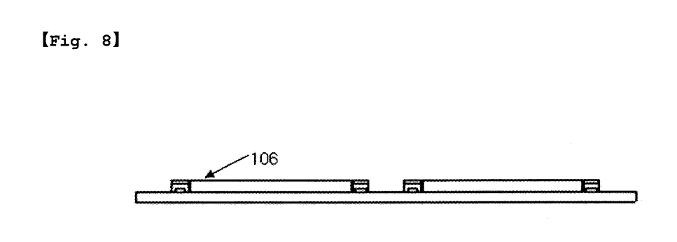

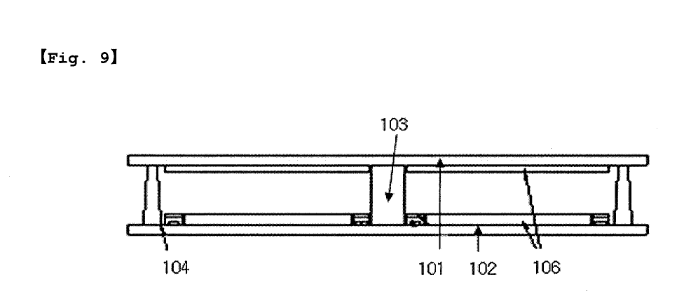

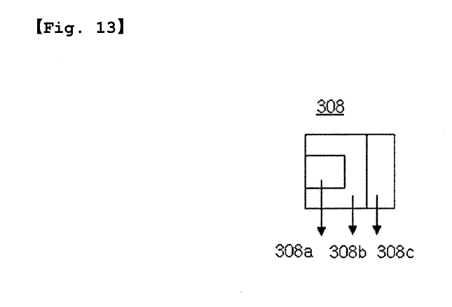

FIG. 13 refers to the detailed configuration of the discharge electrodes 308 of FIG. 11. In accordance with the first embodiment of the present invention, the configuration of the discharge electrodes 308 is similar to that of the conventional discharge electrodes 105 (thus, it may be comprised of a metal layer 308A, a dielectric layer 308B and a protective layer 308C). However, the difference between the protective layer 105C and the protective layer 308C is that the protective layer 105C in FIG. 4 is formed toward the upper direction, but the protective layer 308C in FIG. 13 is toward the right direction. This is because the electrode 308 is formed on the lateral face of partition members 304, 305 and the protective layer 308C is formed on the protective electrode 308. Thus, the protective layer 308C may be toward the left or the right direction, i.e., located at the left or the right side of the partition members 304, 305 as shown in FIG. 11.

Herein, the metal layer 308A may be formed by the screen printing process and then the calcination process; the dielectric layer 308B may be formed on the metal layer 308A by the screen printing process or the laminating process using a DFR (dry film resist); and the protective layer 308C may be formed on the dielectric layer 308B by the sputtering process or the electron beam evaporation process.

By the way, the metal layer 308A may be comprised of not only pure metal but also conductive material such as alloy, metal compound and carbon. It should be noted that this may be applied to other example embodiments of the present invention even without any special comments.

The partition member 305 in the Y direction and the partition member 306 in the X direction may cross at, e.g., right angles. By reference of FIG. 12, it is found that grooves 311, 312 are formed on the partition member 305 in the Y direction and the partition member 306 in the X direction respecitvely, in order to arrange the partition members 305, 306 to be crossed, e.g., at a right angle. It is desirable that the depth of the grooves 311, 312 may be determined to be half of the height of the partition members 305, 306, but it is not limited thereto. Herein, it is possible to select whether the partition member 305 and the partition member 306 cross each other or not if various examples of the design of the flat panel display device are considered. In the meantime, the partition member 304 and the partition member 306 are not necessary to cross each other.

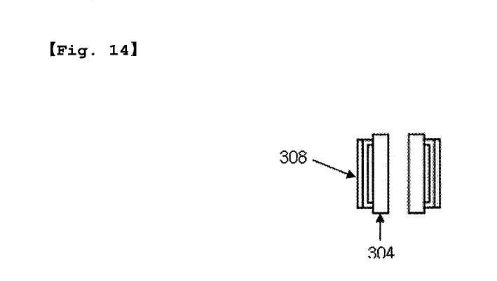

FIG. 14 illustrates an example of a deformed structure of the partition member 305 of FIGS. 11 and 12. That is, the partition member 305 in the Y direction of which the discharge electrodes 308 are built on both sides may be replaced by two partition members 304 in the Y direction of which the discharge electrode 308 is built on one side. In case of the partition member 305, each of the layers, i.e., the metal layer, the dielectric layer and the protective layer, must go through the coating process and then calcinatino process on both sides of the partition member in general, but in case of the partition members 304, the coating process and then calcination process may be applied to only one side of the partition member, and thus, it is easier to manufacture the partition member 304 than the partition member 305. Therefore, by replacing the partition member 305 with two partition members 304, the process for manufacturing the flat panel display panel 300 may become pretty simple. In accordance with the deformed example, space is formed between two partition members 304 by keeping apart the partition members 304 at a certain interval, and thus, a power drive line etc. can go through the space.

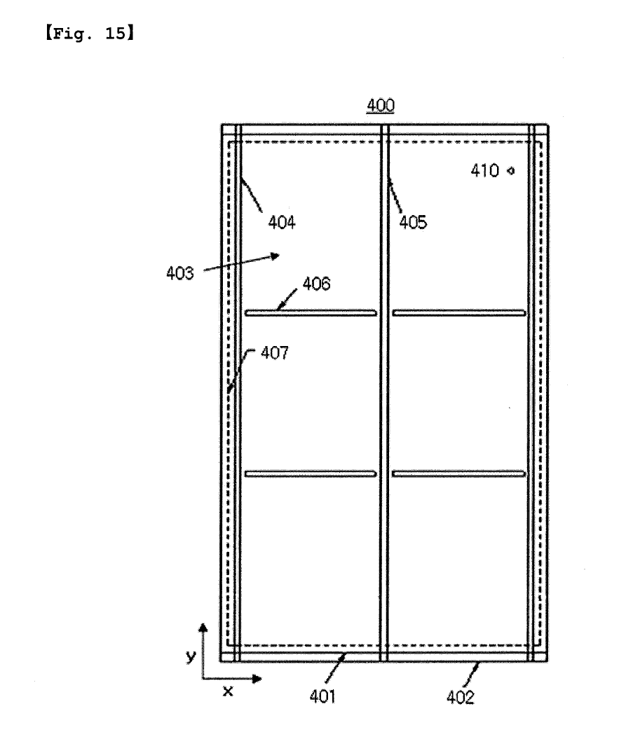

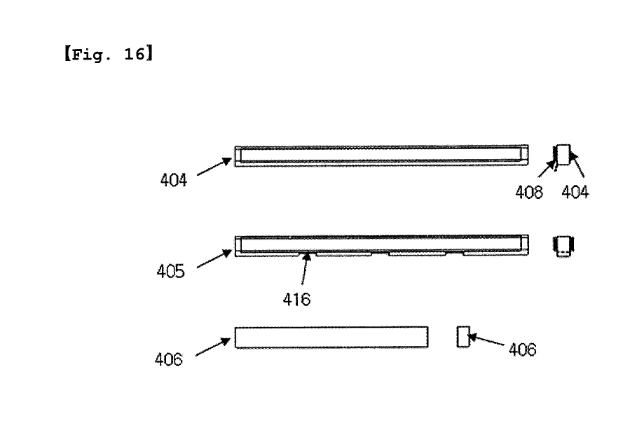

FIGS. 15 through 16 refer to a flat panel display device 400 which includes partition members which do not cross each other in accordance with the second embodiment of the present invention.

Herein, if last two digits of the three digit reference numbers included in FIGS. 10 through 16 are same, it means that a same part is indicated.

First, FIG. 15 refers to the whole configuration of the flat panel display device 400. For the reason that the basic configuration of the flat panel display device 400 is same as that of the flat panel display device 300 except the structure of partition members 404, 405, 406 and the fact that the partition members 405, 406 do not cross each other, the detailed explanation thereabout is omitted.

FIG. 16 shows the structure of the partition members of FIG. 15 in detail. By reference of FIG. 16, a top drawing shows the partition member 404; a middle drawing illustrates the partition member 405; and a bottom drawing presents the partition member 406. Each of the partition members 404, 405, 406 is classified into a left and a right drawings. The left drawing refers to the partition members 404, 405 viewed from the X direction and the partition member 406 viewed from the Y direction; and the right drawing refers to the partition members 404, 405 viewed from the Y direction and the partition member 406 viewed from the X direction. As explained above, this embodiment has the structure in which the partition members 404, 405 along the Y direction and the partition member 406 along the X direction are not overlapped.

The first embodiment in which the partition members are overlapped and the second embodiment in which the partition members are not overlapped have the following differences:

The first embodiment has a strength in that it requires less number of steps included in the assembling process than the second one because each of the partition members in the X direction is united. However, because the first embodiment must have grooves on the partition members 305, 306 to overlap each other, it is not easy to manufacture the partition members 305, 306 so that manufacturing costs may be increased. In addition, the deep groove 311 formed on the partition member 305 in accordance with the first embodiment may weaken the structure of the partition member 305, and the height of the partition member 305 is sharply reduced due to the groove 311 so that the area of a conductor near the groove 311 may be reduced. This may cause the electric field between the electrodes nonuniformly and thus bad effects on the creation of plasma.

Contrary to this, in accordance with the second embodiment, the partition members in the X direction are not united (that is, the partition members 406 are separated). This reduces productivity due to the increased number of steps included in the assembling process. However, it is not necessary to create grooves on the partition members 406 thanks to the non-crossing structure of the partition members and thus it may make the process easier. In addition, contrary to the deep groove structure 311 of the first embodiment, the partition member 405 of the second embodiment has no deep groove, and thus the height of the partition member 405 may be uniform. Thanks to the uniform height of the partition member 405, it is not weak in the structural aspect and it may form the electric field between electrodes uniformly and make the distribution of the plasma uniform. Therefore, possibility of febrility due to the nonuniform electric field may be minimized in accordance with the second embodiment. Herein, the narrow groove 416 formed on the bottom side of the partition member 405 plays a role in discharging the gas in the whole discharge space and in transmitting the injected gas to adjacent discharge cells through the gas inlet 410.

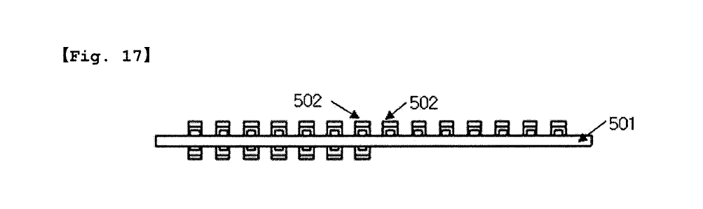

FIGS. 17 through 20 refer to a process for manufacturing the partition members of the flat panel display device in accordance with the first and the second embodiments of the present invention. Contrary to the conventional technology, the discharge electrodes are separately manufactured irrespective of a process for manufacturing the lower substrate. In other words, by reference of FIGS. 17 through 20, multiple partition members and discharged electrodes formed on the lateral faces thereof can be massively produced irrespective of processes for manufacturing the upper and the lower substrates of the flat panel display device.

FIG. 17 presents the step of forming multiple discharge electrodes 502 on a separate glass substrate 501 for manufacturing the partition members. As explained above, the discharge electrodes 502 include the metal layer, the dielectric layer, and the protective layer. Herein, the discharge electrodes are formed on both sides or one side of the glass substrate 501.

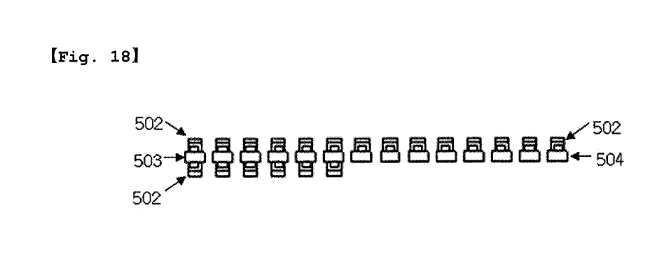

FIG. 18 presents the step of manufacturing multiple partition members by cutting the glass substrates 501 on which the discharge electrodes 502 are formed. By reference of FIG. 18, there are partition members 503 of which the discharge electrodes 502 are built on both sides and partition members 504 of which the electrodes 502 are built on one side. Herein, the partition members 503 correspond with the partition members 305, 405 in the Y direction and the partition members 504 correspond with the partition members 304, 404 in the Y direction. The step of cutting as shown in FIG. 18 may be executed by desirably using saw blades made of diamond or tungsten alloys, by high-pressure waterjet cutting method, or by laser cutting method, but it is not limited thereto.

It should be noted that the order of steps illustrated in FIGS. 17 and 18 are changeable. In other words, it is possible to form the discharge electrodes 502 including the metal layer, the dielectric layer and the preventive layer on a plurality of strip-shpaed glass substrates which were prepared by first cutting the glass substrates 501.

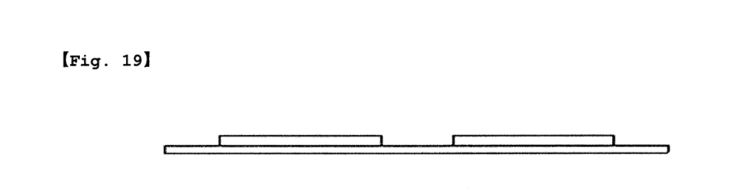

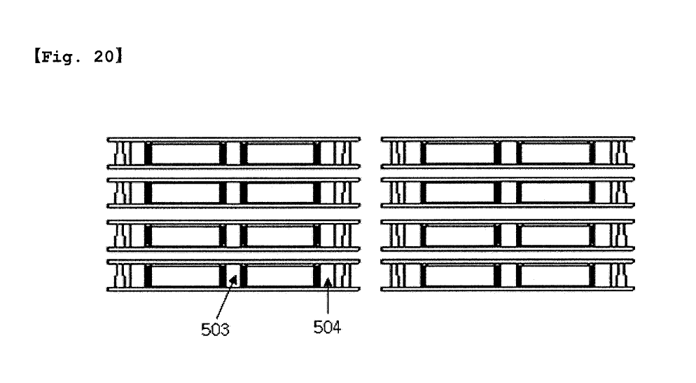

By reference of FIGS. 19 and 20, when the massively produced partition members 503, 504 provided as mentioned above are inserted between the upper and the lower substrates and then the discharge gas is injected in the discharge space, the flat panel display device is finally completed. More specifically, by reference of FIG. 20, the partition member 503 of which the discharge electrodes are built on both sides may be centrally located to thereby divide discharge cells while the partition member 504 of which the discharge electrode is built on one side is located near the edge of the substrates.

The present invention has the following strengths by forming the discharge electrodes during the separate process for manufacturing the partition members:

First, the improvement of productivity, the reduction of the number of stpes included in the whole process, and the automation of the process can be realized because many partition members with discharge electrodes on the lateral face thereof are separately and massively produced and effectively applied to the manufacturing process of the flat panel display device.

Second, it has a strength that it can use low priced soda lime glass for the lower substrate because the discharge electrodes are not formed directly on the lower substrate to which the calcinations process is applied at low temperature after assembling the partition members. According to the conventional technique, high strain point glass was used for the upper and the lower substrates because the discharge electrodes were formed directly on the substrates through the high temperature calcination process. However, the high strain point glass was not desirable because of the higher price than the soda lime glass. The present invention is very meaningful in the overcome of this problem.

Third, the lower substrate is less thermally shocked because it does not go through the high temperature calcination process during the manufacturing process.

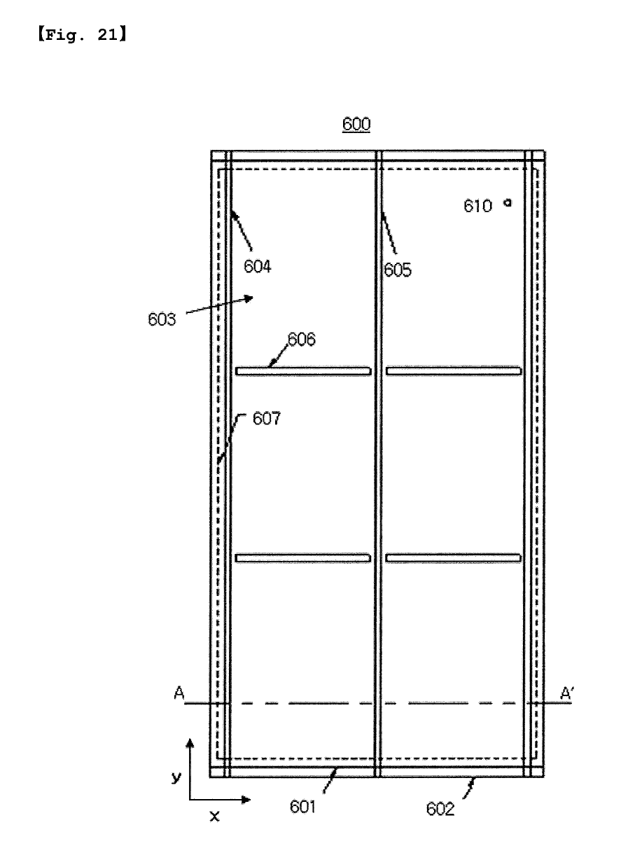

FIGS. 21 through 25 refer to a flat panel display device 600 in accordance with the third embodiment of the present invention.

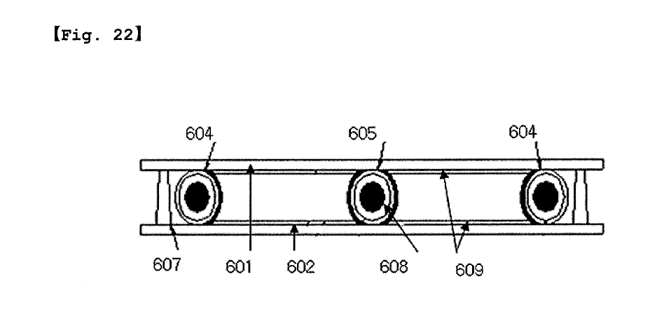

First of all, FIG. 21 shows the whole configuration of the flat panel display device 600 and FIG. 22 refers to the cross section of the flat panel display device 600 viewed from A-A′ of FIG. 21. The basic configuration of the flat panel display device 600 in accordance with the third embodiment of the present invention is almost identical to that of the flat panel display device 300 in accordance with the first embodiment of the present invention. The flat panel display device 600 includes a upper substrate 601, a lower substrate 602, partition members 604, 605, 606, sealant 607, discharge electrodes 608, fluorescent substance 609 and a gas inlet 610.

In accordance with the third embodiment of the present invention, a pair of discharge electrodes 608 for generating the electric field in the discharge space are formed inside of the partition members 604, 605 in the Y direction as shown in FIG. 22. Accordingly, the pair of discharge electrodes 608 in the unit discharge cell 603 may face each other.

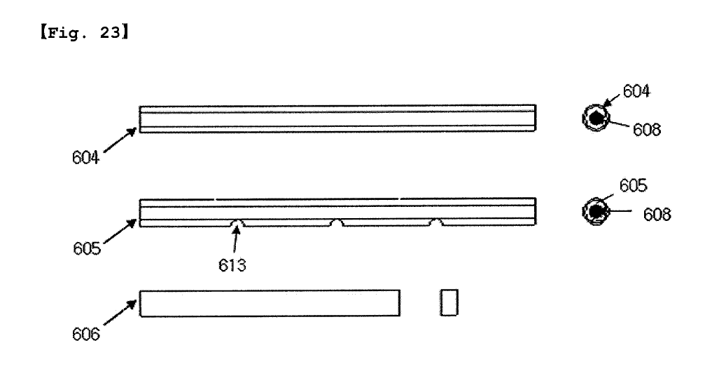

FIG. 23 presents the structure of the partition members of FIG. 21. More specifically, a top drawing shows the partition member 604; a middle drawing presents the partition member 605; and a bottom drawing refers to the partition member 606. Herien, each of the partition members 604, 605, 606 is classified into a left and a right drawings. The left drawing refers to the partition members 604, 605 viewed from the X direction and the partition member 606 viewed from the Y direction; and the right drawing refers to the partition members 604, 605 viewed from the Y direction and the partition member 606 viewed from the X direction.

In accordance with the third embodiment of the present invention, the structure and the arrangement of the partition members are basically same as those in the first embodiment but there are following differences: The cross section of the partition members 604, 605 in the Y direction is round-shaped or empty pipe-shaped overall. Further, a metal rod 608 functioning as a discharge electrode may be inserted into the partition members 604, 605 in the Y direction. Accordingly, there is no difference in the structure of discharge electrodes between the partition member 604 and the partition member 605. However, it is desirable to build a gas passage 613 on the bottom side of the partition member 605 which adjoins two neighboring cells as mentioned in the first embodiment of the present invention.

The cross section of the partition member 606 in the X direction in FIG. 23 is rectangular bar-shaped but it is not limited thereto. For example, the partition member 606 may have a shape of pipe whose central part is empty like the partition members 604, 605. In other example, the partition member 606 may have a shape of pipe whose central part is filled with dielectric material.

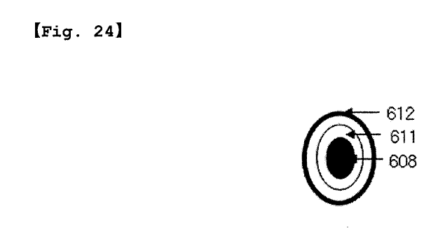

FIG. 24 refers to the structure of the partition members of FIG. 22 in detail. As mentioned above, the metal rods 608 functioning as the discharge electrodes are inserted into the partition members 604, 605 in accordance with the third embodiment of the present invention. Accordingly, contrary to the first and the second embodiments of the present invention, the processes such as a printing step or a dipping step which are required to build the electrodes can be omitted so that the process for building the electrodes may become simplified. In other words, in accordance with the third embodiment of the present invention, a relatively simple process, i.e., a process for inserting metal substance (e.g., metal rod) into each of the glass pipes with an external diameter of a designated specification in which the dielectric material is formed, may be required. Meanwhile, there may be air layer 611 between the partition members 604, 605 and the metal rod 608. In case of the partition member 604 which has one adjacent cell, a glass pipe of which the dielectric layer 612 is formed on one side may be used; and in case of the partition member 605 which has two adjacent cells, a glass pipe of which the dielectric layer 612 is formed on both sides may be used. A protective layer may be formed if necessary on the dielectric layer 612.

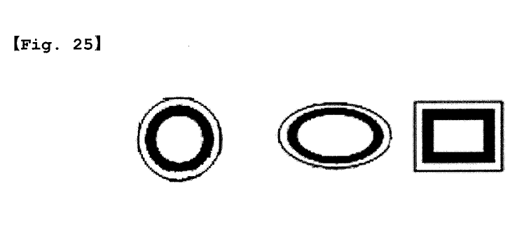

FIG. 25 shows various examples of the partition members 604, 605. By referring to FIG. 25, a pair of discharge electrodes which generate the electric field in the discharge space may also function as the partition member in the Y direction that separates and supports the upper and the lower substrates. That is to say, the metal pipe (the black part in the drawing) plays the roles as a partition member and a discharge electrode at the same time. Moreover, even in the example of FIG. 25, because the conventional printing method or the conventional dipping method can be omitted during the formation of the electrodes, the process for manufacturing the electrodes becomes simplified. In short, in accordance with the third embodiment of the present invention, a simple process of wrapping the dielectric layer around the external surface of the metal substance (e.g., metal pipe) used as the electrode may be required. The protective layer may be formed if necessary on the dielectric layer.

Specifically, FIG. 25 illustrates three various examples of the partition members 604, 605. A left drawing shows the structure of the partition member whose cross section is a circle; a middle drawing shows the structure of the partition member whose cross section is an ellipse; and a right drawing presents the structure of the partition member whose cross section is a square. However, the shape and the thickness of the partition members can be diversely determined within a range in which the role of the partition members can be performed.

While the present invention has been shown and described with respect to the preferred embodiments and figures, it will be understood by those skilled in the art that various changes and modifications may be made without departing from the spirit and the scope of the present invention as defined in the following claims.

1. A flat panel display device, including at least one unit discharge cell, comprising:
an upper and a lower substrates that form a discharge space therebetween and disposed facing each other;
a plurality of partition members disposed between the upper substrate and the lower substrate, the plurality of partition members being configured for supporting and keeping apart the upper and the lower substrates, wherein the upper substrate, the lower substrate and the partition members form at least one unit discharge cell; and
a pair of electrodes, formed on a lateral surface of the partition members, for generating electric field in the discharge space formed in the unit discharge cell,
wherein the pair of electrodes are disposed on a discharge space side of the partition members, and the pair of electrodes are disposed facing each other, and
an internal space is formed inside of the partition members.

2. The device of claim 1, wherein a power drive line passes through the internal space.

3. A flat panel display device, including at least one unit discharge cell, comprising:
an upper and a lower substrates that form a discharge space therebetween and disposed facing each other;
a plurality of partition members disposed between the upper substrate and the lower substrate, the plurality of partition members being configured for supporting and keeping apart the upper and the lower substrates, wherein the upper substrate, the lower substrate and the partition members form at least one unit discharge cell; and
a pair of electrodes, formed on a lateral surface of the partition members, for generating electric field in the discharge space formed in the unit discharge cell,
wherein the pair of electrodes are disposed on a discharge space side of the partition members, and the pair of electrodes are disposed facing each other, and
one or more grooves are formed on the partition members.

4.-18. (canceled)

19. A flat panel display device, including at least one unit discharge cell, comprising:
an upper and a lower substrates that form a discharge space therebetween and disposed facing each other;
plurality of partition members disposed between the upper substrate and the lower substrate, the plurality of partition members being configured for supporting and keeping apart the upper and the lower substrates, wherein the upper substrate, the lower substrate and the partition members form at least one unit discharge cell; and
electrodes, located inside the partition members, for generating electric field in the discharge space formed in the unit discharge cell(s),
wherein a specific electrode located inside a specific partition member of which both sides are in contact with neighboring unit discharge cells is common to the neighboring unit discharge cells.

20. The device of claim 19, wherein the shape of the cross section of the specific partition member includes at least one of a circle, an ellipse, a polyhedron, and a part of the circle, the ellipse, or the polyhedron.

21.-29. (canceled)

30. The device of claim 19, wherein one or more grooves are formed on the partition members.

31.-32. (canceled)

33. The device of claim 19, wherein the electrodes are metal rods inserted into the partition members.

34.-44. (canceled)

45. A method for manufacturing a flat panel display device, including at least one unit discharge cell, discharge space for the unit discharge cells being located between an upper and a lower substrates that form a discharge space therebetween and disposed facing each other, comprising the steps of:
(a) forming multiple electrodes on a reference substrate;
(b) cutting the reference substrate so as to include each of the electrodes; and
(c) inserting the cut electrodes between the upper and the lower substrates,

46. The method of claim 45, wherein, at the step (a), the electrodes are formed on both sides or one side of the reference substrate.

47. The method of claim 46, wherein, at the step (a), a dielectric layer is formed on each of the electrodes which were formed on both sides or one side of the reference substrate.

48. The method of claim 47, wherein, at the step (a), a protective layer is formed on the dielectric layer on both sides or one side of the reference substrate.

49.-51. (canceled)

52. The method of claim 45, wherein the step (b) is performed by using saw blades made of diamond or tungsten alloys, by high-pressure waterjet cutting method, or by laser cutting method.

53. The method of claim 45, wherein, at the step (b), if the electrodes formed on one side of the reference substrate are acquired by cutting the reference substrate, the cut electrodes have a first lamination structure where the reference substrate and the electrode are disposed in a vertical direction in that order; and if the electrodes formed on both sides of the reference substrate are acquired by cutting the reference substrate, the cut electrodes have a second lamination structure where the electrode, the reference substrate, and the electrode are disposed in the vertical direction in that order; and
at the step (c), the reference substrate included in the first and the second lamination structure functions as a supporter between the upper and the lower substrates

54. The method of claim 45, wherein, at the step (b), if the electrodes formed on one side of the reference substrate are acquired by cutting the reference substrate, the cut electrodes have a first lamination structure where the reference substrate and the electrode are disposed in a vertical direction in that order; and if the electrodes formed on both sides of the reference substrate are acquired by cutting the reference substrate, the cut electrodes have a second lamination structure where the electrode, the reference substrate, and the electrode are disposed in the vertical direction in that order; and
at the step (c), the first and the second lamination structures are inserted between the upper and the lower substrates.

55. (canceled)

56. The method of claim 45, wherein, at the step (b), if the electrodes formed on one side of the reference substrate are acquired by cutting the reference substrate, the cut electrodes have a first lamination structure where the reference substrate and the electrode are disposed in a vertical direction in that order; and if the electrodes formed on both sides of the reference substrate are acquired by cutting the reference substrate, the cut electrodes have a second lamination structure where the electrode, the reference substrate, and the electrode are disposed in the vertical direction in that order; and
at the step (c), the first lamination structure functions as a first supporter for the unit discharge cell at a first position where only one face of the first lamination structure adjoins the unit discharge cell, and the second lamination structure functions as a second supporter for the unit discharge cells at a second position where both faces of the second lamination structure adjoin the unit discharge cells.

57.-59. (canceled)
